(19) United States
(12) Patent Application Publication
(10) Pub. No.: US 2019/0199735 A1
(43) Pub. Date: Jun. 27, 2019

(54) DEVICE AND METHOD FOR VERIFYING INTEGRITY OF FIRMWARE

(71) Applicant: Western Digital Technologies, Inc., Irvine, CA (US)

(72) Inventor: Asif F. GOSLA, Irvine, CA (US)

(73) Assignee: Western Digital Technologies, Inc., Irvine, CA (US)

(21) Appl. No.: 15/197,357

(22) Filed: Jun. 29, 2016

(51) Int. Cl. H04L 29/06

(52) U.S. Cl. CPC H04L 63/123; H04L 63/061; H04L 63/0876

(57) ABSTRACT

An electronic device includes a first media configured to store first data and first processing circuitry of the electronic device is configured to control operations of the first media by executing firmware instructions. The electronic device also includes a security device including second media configured to store second data and second processing circuitry configured to decrypt a firmware verification message received from a host device with the unique device key. The second processing circuitry generates an execution image in response to receiving the firmware verification message corresponding to the firmware instructions executed by the first processing circuitry and outputs a firmware verification reply to the host device including the generated execution image and/or representative value.

### BACKGROUND

Data storage devices (DSDs), particularly DSDs in data center environments, can be subject to security attacks where the firmware executed on the DSD becomes compromised. Because DSDs in data centers are cycled on and off infrequently, the firmware loaded on the DSDs at start-up is also re-loaded infrequently so any security vulnerabilities present in the firmware at run-time can be exploited by security attacks that may go undetected for long periods of time.

Once the firmware of a DSD has been compromised, attackers have the ability to gain access to private information such as keys and other data within the DSD. Some DSDs have a security capability where the stored firmware image is verified with a digital signature, which provides confirmation that the correct firmware was loaded but does not provide run-time verification that the execution image is not compromised.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram depicting a system including a host and a Data Storage Device (DSD), according to one example;

FIG. 2A is a block diagram depicting the DSD of FIG. 1, according one example;

FIG. 2B is a block diagram depicting the DSD of FIG. 1, according one example;

FIG. 3 is a swim lane diagram depicting messages exchanged between a DSD and a host during a process for verifying integrity of running firmware, according to one example;

FIG. 4 is a flowchart depicting a method for verifying running firmware initiated by a host server and executing on the security module, according to one example; and

FIG. 5 is a flowchart depicting a method for verifying running firmware that is self-initiated by the security module, according to one example.

In the drawings, like reference numerals designate identical or corresponding parts throughout the several views.

### DETAILED DESCRIPTION

In the following detailed description, numerous specific details are set forth to provide a full understanding of the present disclosure. It will be apparent, however, to one of ordinary skill in the art that the various examples disclosed may be practiced without some of these specific details. In other instances, well-known structures and techniques have not been shown in detail to avoid unnecessarily obscuring the various implementations.

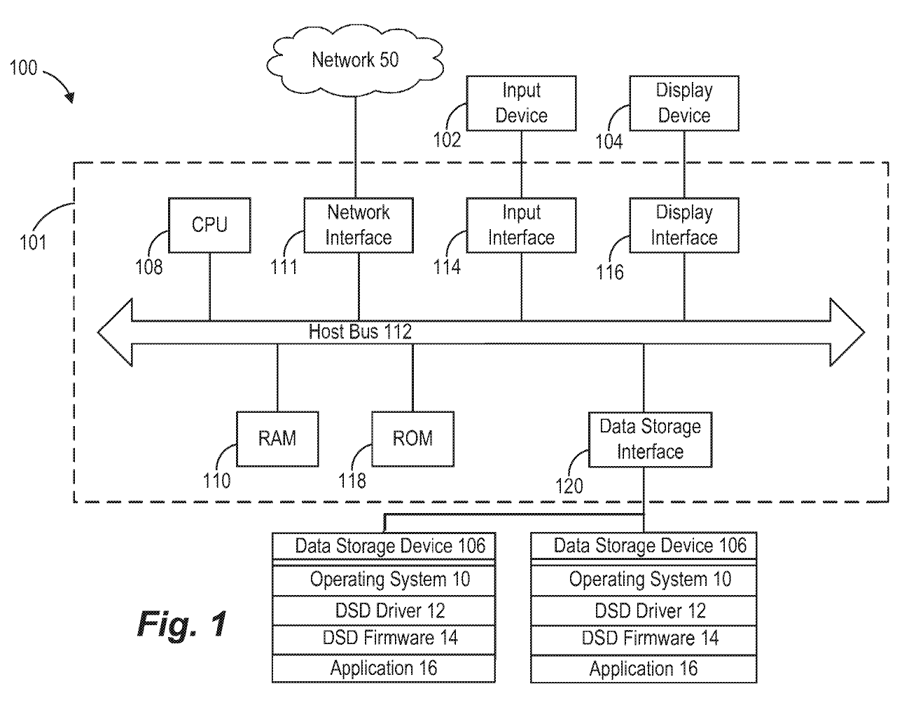

FIG. 1 shows system 100 according to an example which includes host 101, input device 102, display device 104 and at least one Data Storage Device (DSD) 106. System 100 can be, for example, a computer system (e.g., server, desktop, mobile/laptop, tablet, smartphone, etc.) or other electronic device. In this regard, system 100 may be a stand-alone system or part of a network, such as network 50, which can, for example, be a local or wide area network or the Internet. The system 100 can include more or less than those elements shown in FIG. 1 and that the disclosed processes can be implemented in other environments.

In one example, the host 101 is a secure server that is configured to communicate with at least one of the DSD 106 to verify the integrity of firmware running on the DSD 106. For example, the at least one DSD 106 can include data storage devices in a data center that are cycled on and off infrequently, which puts the device firmware at risk for security vulnerabilities that can be exploited by adversaries without detection. The host 101 can transmit an encrypted firmware verification message to the DSD 106 that includes a command to generate a firmware execution image or representative value of the firmware execution image at one or more memory locations of the DSD 106 along with a nonce to prevent replay attacks. A security module included in the DSD 106 decrypts the encrypted firmware verification message with a security key that is unique to the DSD 106, calculates the firmware execution image, and returns a firmware verification reply message to the host 101 that includes the firmware execution image or the representative value (e.g., keyed-hash message authentication code such as HMAC-SHA256) that corresponds to the data at the memory locations of the DSD 106 that are read. The host 101 compares the firmware execution image or representative value to an expected execution image or representative value and determines that the firmware on the DSD 106 has been compromised if the firmware execution image or returned representative value does not correspond to the expected execution image. Details regarding the configuration and operations of the security module of the DSD 106, computation of the firmware execution image, and interactions between the host 101 and DSD 106 are discussed further herein.

Input device 102 can be a keyboard, scroll wheel, or pointing device allowing a user of the system 100 to enter information and commands to the system 100, or to allow a user to manipulate objects displayed on display device 104. In other implementations, input device 102 and display device 104 can be combined into a single component, such as a touch-screen that displays objects and receives user input.

In the example of FIG. 1, the host 101 includes Central Processing Unit (CPU) 108 which can be implemented using one or more processors for executing instructions including a microcontroller, a Digital Signal Processor (DSP), an Application Specific Integrated Circuit (ASIC), a Field Programmable Gate Array (FPGA), hard-wired logic, analog circuitry and/or a combination thereof. The CPU 108 interfaces with host bus 112. Also interfacing with the host bus 112 are Random Access Memory (RAM) 110, input interface 114 for input device 102, display interface 116 for display device 104, Read Only Memory (ROM) 118, network interface 111, and data storage interface 120 for the DSD 106.

RAM 110 is a volatile memory of host 101 that interfaces with host bus 112 so as to provide information stored in RAM 110 to CPU 108 during execution of instructions in software programs such as Operating System (OS) 10, DSD driver 12, or application 16. More specifically, CPU 108 first loads computer-executable instructions from DSD 106 or another DSD into a region of RAM 110. CPU 108 can then execute the stored process instructions from RAM 110. Data such as data to be stored in DSD 106 or data retrieved from DSD 106 can also be stored in RAM 110 so that the data can be accessed by CPU 108 during execution of software programs to the extent that such software programs have a need to access and/or modify the data.

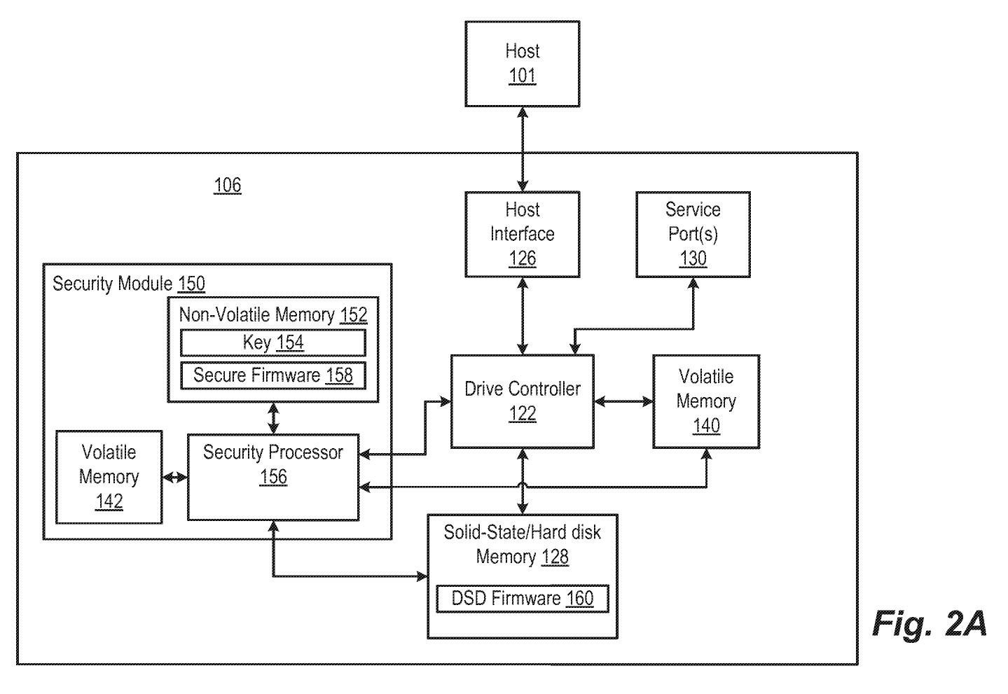

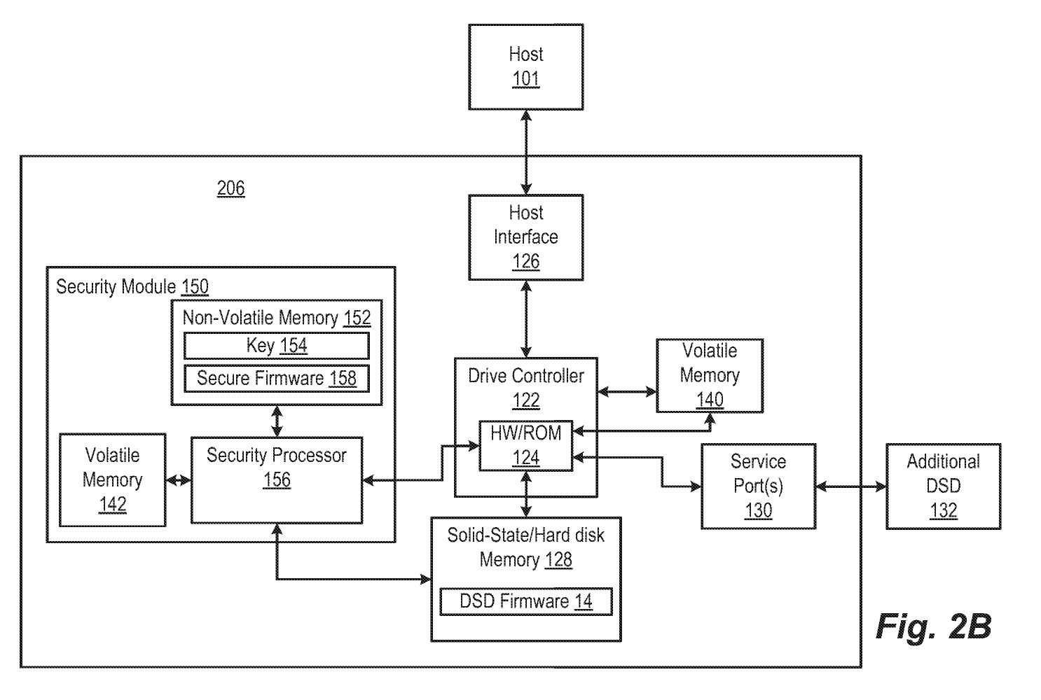

As shown in FIG. 1, DSD 106 can be configured to store one or more of OS 10, DSD driver 12, DSD firmware 14, and application 16. DSD driver 12 provides a software interface for DSD 106 on host 101. DSD firmware 14 includes computer-executable instructions for DSD 106 that control operation of DSD 106 when executed by a controller of DSD 106 (e.g., driver controller 122 in FIG. 2).

Application 16 can be, for example, a program used by host 101 as a tool for interfacing with DSD 106 or a portion of DSD 106. In one implementation, application 16 is an application for the DSD 106 in which use of the application 16 can provide the host 101 with diagnostic and use information about the solid-state/hard disk memory 128 of the DSD 106.

Data storage interface 120 is configured to interface host 101 with DSD 106 and interfaces according to a Serial Advanced Technology Attachment (SATA) standard. In other implementations, data storage interface 120 can interface with DSD 106 using other standards such as, for example, PCI express (PCIe), NVM express (NVMe), or Serial Attached SCSI (SAS).

Although FIG. 1 depicts the co-location of host 101 and DSD 106, in other examples the two need not be physically co-located. In such examples, DSD 106 may be located remotely from host 101 and connected to host 101 via a network interface such as network interface 111.

FIG. 2A is a block diagram depicting components of DSD 106 according to one example. As shown in FIG. 2, DSD 106 includes storage media such as solid-state/hard-disk memory 128 for storing data that can include both solid-state and hard disk media or only solid-state or hard disk media. In this regard, the DSD 106 may be considered a Solid-State Hybrid Drive (SSHD) in that it includes both solid-state Non-Volatile Memory (NVM) media and disk NVM media. In other implementations, the solid-state/hard-disk memory 128 may be replaced by multiple Hard Disk Drives (HDDs) or multiple Solid-State Drives (SSDs), respectively, so that DSD 106 includes pools of HDDs and/or SSDs. As with FIG. 1, those of ordinary skill in the art will appreciate that DSD 106 can include more or less than those elements shown in FIG. 2A and that the disclosed processes can be implemented in other environments. In some implementations, one type of data stored in the solid-state/hard disk memory 128 is DSD firmware 160 that can be loaded to volatile memory 140 and executed by drive controller 122.

As understood by those of ordinary skill in the art, in implementations where the solid-state/hard-disk memory 128 includes HDDs, a disk may form part of a disk pack with additional disks radially aligned below the disk. In addition, a disk head (not shown) may form part of a head stack assembly including additional heads with each head arranged to read data from and write data to a corresponding surface of a disk in a disk pack. The disk can include a number of radial spaced, concentric tracks for storing data on a surface of the disk. Each track can be divided into a number of sectors that are spaced circumferentially along the tracks.

In addition to HDDs, the NVM media of DSD 106 can also include solid-state memory for storing data. While the description herein refers to solid-state memory generally, it is understood that solid-state memory may include one or more of various types of memory devices such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., Single-Level Cell (SLC) memory, Multi-Level Cell (MLC) memory, or any combination thereof), NOR memory, EEPROM, Ferroelectric Memory (FeRAM), Magnetoresistive RAM (MRAM), other discrete NVM chips, or any combination thereof.

In the example of FIG. 2A, drive controller 122 controls operation for solid-state/hard-disk memory 128 and can include circuitry such as one or more processors for executing instructions and can include a microcontroller, a Digital Signal Processor (DSP), an Application Specific Integrated Circuit (ASIC), a Field Programmable Gate Array (FPGA), hard-wired logic, analog circuitry and/or a combination thereof. In one implementation, the drive controller 122 can include a System on a Chip (SoC).

Host interface 126 is configured to interface DSD 106 with host 101 and interfaces with data storage interface 120 according to a Serial Advanced Technology Attachment (SATA) standard. In other implementations, host interface 126 can interface with data storage interface 120 using other standards such as, for example, PCI express (PCIe) or Serial Attached SCSI (SAS). In some examples, host interface 126 can be included as part of drive controller 122. The DSD 106 can also include one or more additional service ports 130 such as serial ports that allow the DSD 106 to communicate with other devices, which may include other DSDs, host devices, or peripheral devices.

Volatile memory 140 can include, for example, a Dynamic Random Access Memory (DRAM) which can be used by DSD 106 to temporarily store data. Data stored in volatile memory 140 can include data read from NVM media (e.g., solid-state/hard-disk memory 128), data to be written to NVM media, instructions loaded from DSD firmware 160 for execution by the drive controller 122, or data used in executing DSD firmware 160. In some implementations, volatile memory 140 may be replaced with a non-volatile memory.

In operation, the host interface 126 receives commands from the host 101 via host interface 126 for reading data from and writing data to the NVM media of DSD 106. In response to a write command from host 101, the drive controller 122 may buffer the data to be written for the write command in volatile memory 140. For data to be written to hard disk, the drive controller 122 can encode the buffered data into a write signal which can be magnetically written data to the hard disk of the solid-state/hard-disk memory 128.

In response to a read command for data stored on a HDD of the solid-state/hard disk memory 128, the drive controller 122 positions the disk head via a control signal to magnetically read the data stored on the surface of disk. The disk head sends the read data as read signal to the drive controller 122 for decoding, and the data is buffered in volatile memory 140 for transferring to the host 101. For data to be stored in a SSD of the solid-state/hard disk memory 128, the drive controller 122 receives data from host interface 126 and encodes the data into charge values for charging cells of the SSD to store the data. In response to a read command for data stored in the SSD of the solid-state/hard disk memory 128, the drive controller 122 reads current values for cells in the SSD and decodes the current values into data that is transferred to host 101 via host interface 126.

The DSD 106 also includes security module 150, which is a device within the DSD 106 that is inaccessible by other controllers of the DSD 106, such as the drive controller 122. The security module 150 operates independently from the other components of the DSD 106 and includes a security processor 156, non-volatile memory (NVM) 152, and working volatile memory 142.

In the example of FIG. 2A, the security processor 156 controls verification of the firmware running on the DSD 106 and can include processing circuitry such as one or more processors for executing instructions and can include a microcontroller, a Digital Signal Processor (DSP), an Application Specific Integrated Circuit (ASIC), a Field Programmable Gate Array (FPGA), hard-wired logic, analog circuitry and/or a combination thereof. In one implementation, the security processor 156 can include a System on a Chip (SoC).

The NVM 152 of the security module 150 provides a storage medium for data such as at least one device-specific key 154 that is securely stored in the NVM 152. The key 154 can include a root key that is pre-configured, unchangeable, unique to the DSD 106, and can be loaded during manufacturing of the DSD 106 or can be generated by the security module 150. The at least one key 154 can also include a key that is used to establish a secure connection with the host 101, a key that is used to decrypt the firmware verification message received from the host 101 and/or encrypt a firmware verification reply, and a key that is used to generate the representative value of the execution image. In some implementations, the root key is stored in the NVM 152 or eFUSE configuration and is used to access the other device-specific keys from the solid-state/hard disk memory 128 or volatile memory 140 that are used by the security processor 156 for the various other functions.

In one example, the NVM 152 of the security module 150 can also store secure firmware 158 that is executed by the security processor 156. The secure firmware 158 may also be stored in the solid-state/hard disk memory 128 of the DSD 106, which is accessed by the security processor 156. In implementations where the secure firmware 158 is stored in the solid-state/hard disk memory 128, the security processor 156 verifies that the secure firmware 158 has not been compromised prior to executing instructions of the secure firmware 158.

Volatile memory 142 of the security module 150 can include, for example, a Dynamic Random Access Memory (DRAM) which can be used by the security module 150 to temporarily store data. Data stored in volatile memory 142 can include data read from the NVM 152, data to be written to the NVM 152, instructions loaded from the secure firmware 158 for execution by the security processor 156, or data used in executing the secure firmware 158.

The processing circuitry of the security processor 156 executes one or more software processes associated with verifying the integrity of the DSD firmware 160 running on the DSD 160 in response to receiving a firmware verification message from the host 101. In some implementations, the firmware verification message includes a pass-through command indicating that the firmware verification message is directed to the security module 150 so that the drive controller 122 directs the firmware verification message to the security module 150 without intercepting or modifying the firmware verification message. The security processor 156 decrypts the firmware verification message with the key 154 stored in the NVM 152, solid-state/hard disk memory 128, or volatile memory 140 and accesses the solid-state/hard disk memory 128 and/or volatile memory 140 to compute a firmware execution image or representative value that is a representation of the DSD firmware 160 currently being executed by the drive controller 122. The security processor 156 generates a firmware verification reply that is transmitted to the host 101, which can include the firmware execution image or the representative value that is a representation of the firmware execution image along with a nonce that was sent as part of the firmware verification message from the host 101. In some implementations, the security processor 156 can also initiate firmware verifications independently without receiving a firmware verification message from the host 101. Details regarding the processes performed by the security processor 156 are discussed further herein.

FIG. 2B is a block diagram depicting components of DSD 206 according to one example. The DSD 106 depicted in FIG. 2B is another implementation of the DSD 106 and can be configured so that the security module 150 can interface with multiple DSDs external to the DSD 206 in order to perform integrity verifications of the running firmware on the multiple DSDs according to the processes described further herein. In addition to the components of the DSD 106, the drive controller 122 of the DSD 206 includes an additional hardware/ROM (HW/ROM) block 124 that provides an interface between the security processor 156 and the memories 128 and 140 of the DSD 206 as well as memories of at least one additional DSD 132 that interface with the HW/ROM block 124 of the drive controller 122 via at least one of the service ports 130. The drive controller 122 forwards firmware verification messages received from the host 101 to the security module 150 which may specify which of the additional DSDs 132 to include in the firmware integrity verification.

Security keys associated with the additional DSDs 132 may be stored in the NVM 152 or in an eFUSE configuration but may also be stored in memory of the additional DSDs 132. In response to receiving a firmware verification message from the host 101 that indicates at least one of the additional DSDs 132 to check, the security processor 156 can access the security keys for the additional DSDs 132 with the root key stored in the NVM 152 or another security key and directly accesses the memories of the additional DSD 132 to compute the firmware execution image for the additional DSD 132. The security processor 156 generates a firmware verification reply for the additional DSD 132 that is transmitted to the host 101, which can include the firmware execution image or representative value that is a representation of the firmware execution image along with a nonce that was sent as part of the firmware verification message from the host 101. In some implementations, the security processor 156 can also initiate firmware verifications of the at least one additional DSD 132 independently without receiving a firmware verification message from the host 101.

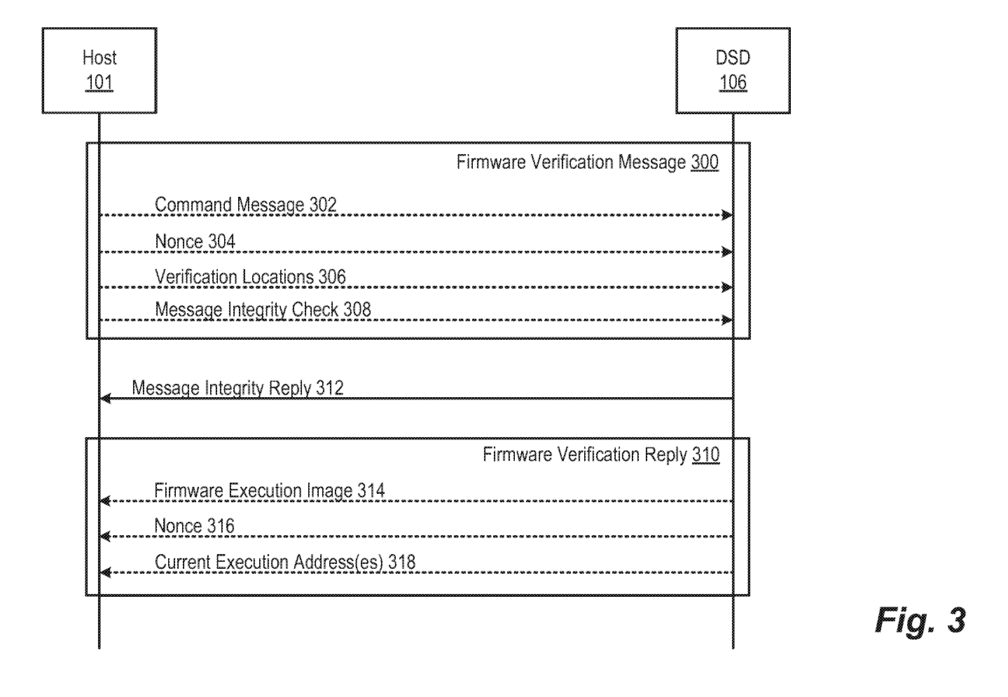

FIG. 3 is a diagram depicting messages exchanged between the DSD 106 and the host 101 during a process for verifying integrity of running firmware, according to one example. In one example, the host 101 initiates the firmware integrity verification process by transmitting firmware verification message 300 to the DSD 106 via the host interface 126. The firmware verification message 300 is encrypted with the security key 154 of the DSD 106 so that an unauthorized device is unable to intercept and properly decrypt the firmware verification message 300. In addition, the firmware verification message 300 includes a pass-through command indicating that the firmware verification message is directed to the security module 150 so that the drive controller 122 directs the firmware verification 300 message to the security module 150 without intercepting or modifying the firmware verification message 300.

In some implementations, the firmware verification message 300 includes one or more message components such as a command message 302, a nonce 304, verification locations 306 in the solid-state/hard disk memory 128 or volatile memory 140 for the security module 150 to check, and a message integrity check component 308. The command message 302 is a control message from the host 101 to the DSD 106 indicating a particular task to perform, such as performing a verification of the firmware being executed by the DSD 106. In some implementations where the security module 150 performs firmware integrity verifications for the at least one additional DSD 132 as with the DSD 206, the command message 302 can indicate the specific additional DSDs 132 for the security module 150 to verify. A randomly-generated nonce 304 is also included in the firmware verification message 300 to prevent replay attacks that may occur, and in some examples, the nonce 304 is used by the security processor 156 to compute the firmware execution image.

In some implementations, the host 101 can initiate a partial integrity verification check of the running firmware on the DSD 106 by including the verification locations 306 that indicate specific address locations to be verified within the solid-state/hard disk memory 128 and/or volatile memory 140. In some implementations, the partial integrity verification checks can be performed at a first predetermined time interval at varied memory locations, and full integrity verification checks of all memory locations within the DSD 106 can be performed at a second predetermined time interval that may be longer than the time interval of the partial integrity verification checks so that full integrity checks are performed less frequently than partial firmware integrity checks. In one example, an amount of code encompassed by a partial firmware verification check may be based on an execution time of the partial firmware verification check. For example, as a processing capacity of the security processor 156 increases, the amount of code encompassed by the partial firmware verification check may be increased. Also, verification locations 306 of the partial integrity validation check may be based on expected locations of firmware code that is currently being executed by the drive controller 122. When a full integrity check of all memory locations is initiated, the firmware verification message 300 may not include the verification locations 306.

The firmware verification message 300 may optionally include a message integrity check 308 that allows the host 101 to verify that the firmware verification message 300 was received by the DSD 106 without being tampered with to isolate a location of an attack. For example, the message integrity check 308 may be a type of signature validation message. When the security module 150 receives the message integrity check 308, the security processor 156 transmits a message integrity reply 312 back to the host 101 that includes the signature validation. If the message integrity reply 312 received by the host does not correspond to an expected reply, then the host 101 can determine that the firmware verification message 300 was tampered with before reaching the DSD 106. In some implementations, the message integrity reply 312 may be transmitted from the DSD 106 to the host 101 in a separate message from a firmware verification reply 310.

The processing circuitry of the security processor 156 executes one or more software processes associated with verifying the integrity of the DSD firmware 160 running on the DSD 160 in response to receiving a firmware verification message from the host 101. The security processor 156 decrypts the firmware verification message with a messaging key and accesses the solid-state/hard disk memory 128 and/or volatile memory 140 to compute a firmware execution image that is a representation of the DSD firmware 160 currently being executed by the drive controller 122. The security processor 156 generates the firmware verification reply 310 that is encrypted with the security key 154 and transmitted to the host 101, which can include the firmware execution image 314 or a representative value (e.g., HMAC-SHA256, or SHA256) that is a representation of the firmware execution image along with the nonce 316 that was sent as part of the firmware verification message 300 from the host 101. The firmware verification reply 310 can also include one or more current execution addresses 318 that correspond to memory locations of firmware instructions that are currently being executed by the drive controller 122 of other processors within the DSD 106. The host 101 can determine differences between the retuned execution addresses 318 and expected execution addresses to detect security vulnerabilities or attacks.

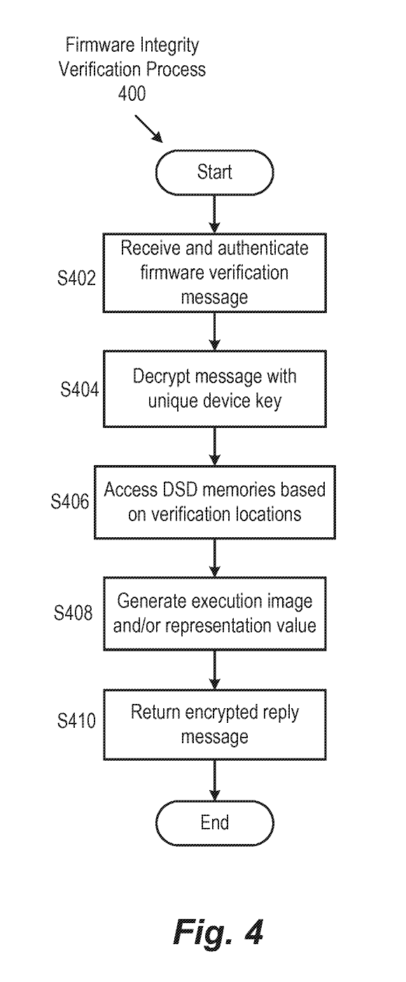

FIG. 4 is an exemplary flowchart of a firmware integrity verification process 400 that is initiated by the host 101, according to one example. The firmware integrity verification process 400 is described herein with respect to the DSD 106, but the process 400 can also be performed by other types of DSD configurations that include the security module 150, such as the DSD 206.

At step S402, the security processor 156 receives and authenticates the firmware verification message 300 received from the host 101. In one example, the host 101 initiates the firmware integrity verification process by transmitting the firmware verification message 300 to the DSD 106 via the host interface 126. The firmware verification message 300 is encrypted with the security key 154 of the DSD 106 so that an unauthorized device is unable to intercept and properly decrypt the firmware verification message 300. In addition, the firmware verification message 300 includes a pass-through command indicating that the firmware verification message is directed to the security module 150 so that the drive controller 122 directs the firmware verification 300 message to the security module 150 without intercepting or modifying the firmware verification message 300.

The firmware verification message 300 may optionally include a message integrity check 308 that allows the host 101 to verify that the firmware verification message 300 was received by the security module 150 without being tampered with in flight in order to isolate a location of an attack. For example, the message integrity check 308 may be a type of signature validation message. To authenticate the firmware verification message, the security processor 156 transmits the message integrity reply 312 back to the host 101 via the drive controller 122 and host interface 126 that includes the signature validation. If the message integrity reply 312 received by the host 101 does not correspond to an expected reply, then the host 101 can determine that the firmware verification message 300 was tampered with in flight to the DSD 106.

At step S404, the security processor 156 decrypts the firmware verification message 300 with the messaging key that is unique to the DSD 106 in order to access and determine the components of the firmware verification message 300. If an attacker attempts to decrypt the firmware verification message 300 with an incorrect key, then the attacker would be unable to access the contents of the firmware verification message 300. An attacker may incorrectly identify the nonce 304 or verification locations 306 by using an incorrect key to decrypt the message, and the host 101 can determine that the generated firmware execution image does not correspond to an expected firmware execution image.

At step S406, the security processor 156 accesses one or more memory locations of the solid-state/hard disk memory 128 or volatile memory 140 based on the verification locations 306 in the firmware verification message 300. The security processor 156 has direct access to all of the storage media within the DSD 106 or the at least one additional DSD 132 in the case of the DSD 206 in order to compute the firmware execution image. In some implementations, the security processor 156 performs a read of the volatile memory 140 at the verification locations 306, which includes bytes that contain firmware machine instructions.

At step S408, the security processor 156 generates a firmware execution image 314 based on executed firmware code and/or constant data (e.g., device serial number, number of disk heads, etc.) at the verification locations 306 in the solid-state/hard disk memory 128 or volatile memory 140. The firmware execution image 314 is a footprint or representation of actual firmware code and/or constant data that is executed by the drive controller 122 at runtime, which can provide an indication of whether or not the firmware has been hacked or compromised during runtime execution of the firmware. In some implementations, the execution image can be generated based on read-only data that can include any internal firmware variables that are not modified at runtime. The firmware execution image 314 that is generated from firmware at runtime may be a better indicator of firmware integrity than execution images that are generated at firmware download or boot time. Also, the security processor 156 may also compute a representative value of the firmware execution image 314 (e.g., HMAC-SHA256, SHA256) with a unique key. In some implementations, the unique key is stored in the solid-state/hard disk memory 128 or volatile memory 140 and is accessed by the security processor 156 with a device-specific root key stored in the NVM 152. In addition, the representative value of the firmware execution image may also be computed with the nonce 304 that was transmitted with the firmware verification message 300. In some implementations, the security processor 156 also identifies execution addresses 318 that correspond to the memory addresses of the firmware code that is currently being executed by the drive controller 122. If the drive controller 122 includes more than one processor, then the security processor 156 can identify execution addresses for each of the processors that are executing firmware.

At step S410, the security processor 156 generates the firmware verification reply 310 that is transmitted to the host 101 via the drive controller 122 and host interface 126. In some implementations, security processor 156 encrypts the firmware verification reply 310 with the messaging key which can be decrypted upon reception by the host 101. The firmware verification reply 310 can include the firmware execution image 314 or a representative value of the firmware execution image 314 along with the nonce 316 that was sent as part of the firmware verification message 300 from the host 101. The firmware verification reply 310 can also include one or more current execution addresses 318 that correspond to memory locations of firmware instructions that are currently being executed by the drive controller 122 of other processors within the DSD 106.

The host 101 can determine that the generated execution image corresponds to the expected execution image if the firmware execution image is identical to the expected execution image or if an amount of correspondence between the generated firmware execution image and the expected execution image is greater than a predetermined threshold. If a representative value of the firmware execution image is produced at step S408, the host 101 can determine that the generated representative value corresponds to the expected representative value when an amount of correspondence between the generated representative value and the expected representative value is greater than a predetermined threshold. The host 101 can also compare the execution addresses of the firmware code that is currently being executed by the drive controller 122 to expected execution addresses to detect whether a compromise of the firmware security has occurred.

The host 101 can determine the expected execution image or representative value based on a current version of the DSD firmware that is stored in memory of the host 101. For example, the host 101 can use the verification locations and expected execution addresses of the firmware to compute the expected execution image that is compared to the firmware execution image computed by the security processor 156.

If the host 101 determines that the firmware execution image 314, nonce 316, or current execution addresses 318 do not correspond to expected values, then the host 101 may determine that the DSD firmware 160 has been compromised and may issue control signals to shut down the DSD 106 or reload the DSD firmware 160 or other firmware that is known to be uncompromised or may issue a control signal to shut down the DSD 106.

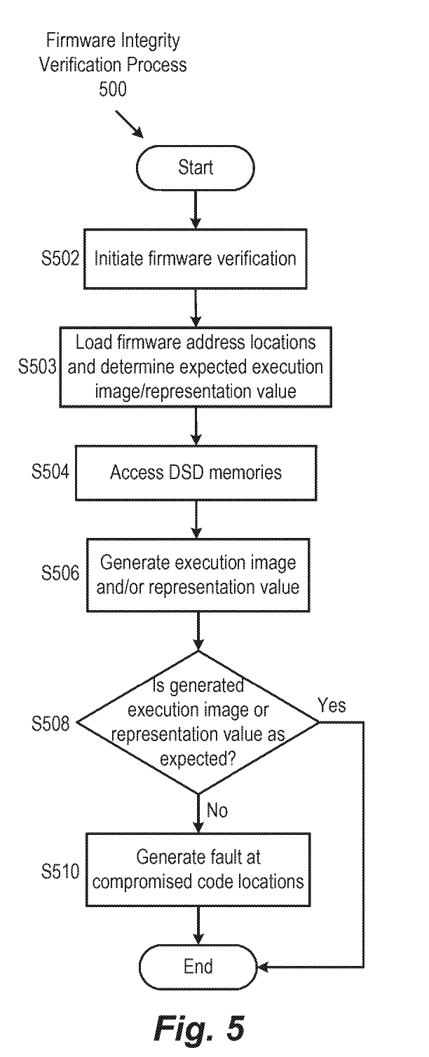

FIG. 5 is an exemplary flowchart of a firmware integrity verification process 500 that is initiated by the security module 150, according to one example. The firmware integrity verification process 500 is described herein with respect to the DSD 106, but the process 500 can also be performed by other types of DSD configurations that include the security module 150, such as the DSD 206.

At step S502, the security processor 156 initiates a verification check of the integrity of the DSD firmware 160 that is executed by the drive controller 122. In some implementations, the security processor 156 can initiate a partial integrity verification check of the running firmware on the DSD 106 at one or more specific address locations of the solid-state/hard disk memory 128 and/or volatile memory 140 that may correspond to memory locations of firmware code that is currently being executed by the drive controller 122, has been executed by the drive controller 122 since a previous verification check was initiated, or will be executed by the drive controller 122 before a next verification check is initiated. In some implementations, the partial integrity verification checks can be performed at a first predetermined time interval (frequency) at varied memory locations, and full integrity verification checks of all memory locations within the DSD 106 can be performed at a second predetermined time interval (frequency) that may be longer than the time interval of the partial integrity verification checks so that full integrity checks are performed less frequently than partial firmware integrity checks. In one example, an amount of code encompassed by a partial firmware verification check may be based on an execution time of the partial firmware verification check. For example, as a processing capacity of the security processor 156 increases, the amount of code encompassed by the partial firmware verification check may be increased. Also, the verification locations of the partial integrity verification check may be based on expected locations of firmware code that is currently being executed by the drive controller 122.

At step S503, the security processor 156 loads and verifies execution image address locations and determines an expected execution image or representative value for the address locations encompassed by the firmware verification check. For example, the security processor 156 can load an execution address file from solid state/hard disk memory 128 or volatile memory 140 to determine the address locations for the firmware verification check.

In addition, the execution address file can also include expected execution images and representative values associated with various memory verification locations. The execution address file may be encrypted with a key that is decrypted by the security processor 156 to ensure that the execution address file has not been tampered with. The security processor 156 can also determine the expected execution image or representative value for the initiated verification check based on a current version of the DSD firmware 160 that is stored in the solid-state/hard disk memory 128. For example, the security processor 156 can use the verification locations and expected execution addresses of the firmware to compute the expected execution image that is compared to the generated firmware execution image at step S508.

At step S504, the security processor 156 accesses one or more memory locations of the solid-state/hard disk memory 128 and/or volatile memory 140 based on the firmware code verification locations determined at step S502. The security processor 156 has direct access to all of the storage media within the DSD 106 or the at least one additional DSD 132 in the case of the DSD 206 in order to compute the firmware execution image. In some implementations, the security processor 156 performs a read of the volatile memory 140 at the verification locations 306, which includes bytes that contain firmware machine instructions.

At step S506, the security processor 156 generates a firmware execution image that is computed based on firmware code and/or constant data (e.g., device serial number, number of disk heads, etc.) at the verification locations in the solid-state/hard disk memory 128 and/or volatile memory 140. The firmware execution image is a footprint or representation of actual firmware code and/or constant data that is executed by the drive controller 122, which can provide an indication of whether or not the firmware has been hacked or compromised at run-time. Also, the security processor 156 may also compute a representative value of the firmware execution image (e.g., HMAC-SHA256, SHA256) with a unique key. In some implementations, the unique key is stored in the solid-state/hard disk memory 128 or volatile memory 140 and is accessed by the security processor 156 with a device-specific root key stored in the NVM 152. In some implementations, the security processor 156 also identifies execution addresses that correspond to the memory addresses of the firmware code that is currently being executed by the drive controller 122. If the drive controller 122 includes more than one processor, then the security processor 156 can identify execution addresses for each of the processors that are executing firmware.

At step S508, the security processor 156 determines an amount of correspondence between the generated execution image and the expected execution image determined at step S502 when the firmware verification was initiated to determine whether the firmware executed by the device controller 122 has been compromised. The security processor 156 can determine that the generated execution image corresponds to the expected execution image if the firmware execution image is identical to the expected execution image or if an amount of correspondence between the generated firmware execution image and the expected execution image is greater than a predetermined threshold. If a representative value of the firmware execution image is produced at step S506, the security processor 156 can determine that the generated representative value corresponds to the expected representative value when all an amount of correspondence between the generated representative value and the expected representative value is greater than a predetermined threshold. The security processor 156 can also compare the execution addresses of the firmware code that is currently being executed by the drive controller 122 to expected execution addresses to detect whether a compromise of the firmware security has occurred.

If the security processor 156 determines that an amount of correspondence between the generated execution image or representative value of the execution image and the expected execution image is greater than or equal to a predetermined threshold, resulting in a “yes” at step S508, then the firmware integrity verification process 500 is terminated. Otherwise, if the security processor 156 determines that the amount of correspondence between the generated execution image or representative value of the execution image and the expected execution image is less than the predetermined threshold, resulting in a “no” at step S508, then step S510 is performed.

At step S510, if it is determined at step S508 that the generated execution image or representative value of the execution image does not correspond to the expected execution image, then the security processor 156 generates a fault at one or more compromised code locations that may correspond to the memory locations that were accessed at step S504. The security processor 156 may also be able to determine the compromised code locations based on determined differences between the generated execution image or representative value and the expected execution image. When the fault is generated, the security processor 156 can output an alert to an end user via the host 101 or can directly output the alert via an alarm or other alert mechanism that may be connected or integral to the DSD 106. In some implementations, when the fault associated with the compromised firmware is generated, the security processor 156 can output a control signal to the drive controller 122 to reload the DSD firmware 160 or other code that is known to not be compromised or to shut down the DSD 106.

The implementations described previously herein regarding verifying the integrity of running firmware on DSDs improve the ability of host devices or the DSDs themselves to detect security comprises that may occur in the device firmware at run-time from malicious attacks so that the data stored in the DSDs can be protected, and uncompromised firmware can be reloaded on the DSDs. Including an independent security module within the DSDs that has access to a unique device security key, performs the firmware verification checks, and is inaccessible from other controllers or processors within the DSDs reduces a likelihood that a firmware verification message is intercepted by a malicious attacker who in turn forges a firmware verification reply message. Also, because the firmware verification message is encrypted with the unique device key, only the security module is able to correctly decrypt the message, and the nonce included in the firmware verification message allows replay attacks to be detected. In addition, the firmware execution image is generated based on run-time execution code to ensure that uncompromised firmware code is being executed, which allows for more prompt detection and resolution of security vulnerabilities.

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes a processor, controller, or computer to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, and controllers described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The activities of a method or process described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit ASIC.

The foregoing description of the disclosed examples is provided to enable any person of ordinary skill in the art to make or use the implementations in the present disclosure. Various modifications to these examples will be readily apparent to those of ordinary skill in the art, and the principles disclosed herein may be applied to other examples without departing from the spirit or scope of the present disclosure. The described examples are to be considered in all respects only as illustrative and not restrictive and the scope of the disclosure is, therefore, indicated by the following claims rather than by the foregoing description. All changes which come within the meaning and range of equivalency of the claims are to be embraced within their scope.

1. An electronic device comprising:
a first media configured to store first data;
first processing circuitry configured to control operations of the first media by executing firmware instructions; and
a security device including
a second media configured to store second data; and
second processing circuitry configured to
decrypt a firmware verification message received from a host device using a first unique device key at the security device;
generate an execution image in response to receiving the firmware verification message corresponding to the firmware instructions executed by the first processing circuitry; and
output a firmware verification reply to the host device including the generated execution image.

2. The electronic device of claim 1, wherein
the security device is inaccessible by the first processing circuitry.

3. The electronic device of claim 1, wherein
the firmware verification message includes a nonce encrypted with the first unique device key.

4. The electronic device of claim 2, wherein
the firmware verification message includes one or more verification locations indicating a portion of the firmware instructions to be included in the execution image.

5. The electronic device of claim 4, wherein
the second processing circuitry is further configured to access one or more memories of the first media based on the one or more verification locations.

6. The electronic device of claim 1, wherein
the second processing circuitry is further configured to generate the execution image based on at least one of firmware code or constant data stored in the first media.

7. The electronic device of claim 1, wherein
the second processing circuitry is further configured to generate the execution image based on a nonce included in the firmware verification message.

8. The electronic device of claim 1, wherein
the firmware verification reply includes a nonce included in the firmware verification message and one or more memory addresses associated with current code execution locations of the first media.

9. The electronic device of claim 1, wherein
the firmware verification message includes a message integrity check.

10. The electronic device of claim 9, wherein
the second processing circuitry is further configured to output a message integrity reply to the host device in response to receiving the message integrity check.

11. The electronic device of claim 1, wherein
the second processing circuitry is further configured to output the firmware verification reply with a representative value of the generated execution image computed based on a second unique device key.

12. The electronic device of claim 11, wherein
the firmware verification message includes a pass-through command indicating that the firmware verification message is directed to the security device.

13. The electronic device of claim 1, wherein
the second processing circuitry is further configured to initiate a firmware verification at a first predetermined frequency.

14. The electronic device of claim 13, wherein
the second processing circuitry is further configured to determine one or more verification locations indicating a portion of the firmware instructions to be included in the execution image based on current code execution locations of the first media.

15. The electronic device of claim 13, wherein
the second processing circuitry is further configured to initiate a partial firmware verification at a second predetermined frequency that is more frequent than the first predetermined frequency.

16. The electronic device of claim 15, wherein
the second processing circuitry is further configured to determine an amount of code encompassed by a partial firmware verification based on an execution time of the partial firmware verification.

17. The electronic device of claim 1, wherein
the second processing circuitry is further configured to compare the generated execution image to an expected execution image.

18. The electronic device of claim 17, wherein
the second processing circuitry is further configured to identify one or more compromised code locations when an amount of correspondence between the generated execution image and the expected execution image is less than a predetermined threshold.

19. A method of verifying integrity of firmware of an electronic device including a first media for storing first data and first processing circuitry configured to control operations of the first media by executing firmware instructions, the method comprising:
decrypting, by second processing circuitry of the electronic device including a second media configured to store second data, a firmware verification message received from a host device using a unique device key from the second media;
generating, by the second processing circuitry, an execution image in response to receiving the firmware verification message corresponding to the firmware instructions executed by the first processing circuitry; and
outputting, to the host device, a firmware verification reply including the generated execution image.

20. A non-transitory computer readable medium including computer program instructions, which when executed by first processing circuitry included in an electronic device including a first media for storing data and second processing circuitry configured to control operations of the first media by executing firmware instructions, cause the first processing circuitry to:
decrypt a firmware verification message received from a host device using a unique device key;
generate an execution image in response to receiving the firmware verification message corresponding to the firmware instructions executed by the second processing circuitry; and
output a firmware verification reply including the generated execution image.
